(19) United States
(12) Patent Application Publication
(10) Pub. No.: US 2026/0268469 A1
(43) Pub. Date: Sep. 10, 2026

(54) METHOD AND SYSTEM FOR PATH PLANNING OF BINOCULAR VISION-BASED INSPECTION MACHINE FOR SUBSTRATES

(71) Applicant: Guangdong University of Technology, Guangzhou (CN)

(72) Inventors: Hao ZHANG, Guangzhou (CN); Qiang LIU, Guangzhou (CN); Bozheng HE, Guangzhou (CN); Wentao JIANG, Guangzhou (CN); Lijun WEI, Guangzhou (CN)

(21) Appl. No.: 19/642,632

(22) Filed: Apr. 9, 2026

(30) Foreign Application Priority Data
Jun. 12, 2025 (CN) 202510782174.6

(51) Int. Cl. G06T 7/00; G06T 7/60; G06T 7/80

(52) U.S. Cl. CPC G06T 7/0004; G06T 7/60; G06T 7/85; G06T 2207/10012; G06T 2207/30141

(57) ABSTRACT

A path planning method for a binocular vision-based inspection machine for substrates, in which (S1) dimensional data of a printed circuit board (PCB) substrate and two camera lens modules are analyzed and processed; (S2) a division scheme based on hole position characteristics of the PCB substrate and processed dimensional data is designed, and the PCB substrate is divided into regions based on the camera lens modules according to the division scheme; working ranges of the camera lens modules are constrained according to sizes and travel ranges of the camera lens modules; (S3) an integer programming model for task pairing scheduling for the camera lens modules is established; and (S4) a single-region path planning is performed algorithm, where for each of the two camera lens modules, a shortest path connecting all inspection holes within a current region is determined using a variable neighborhood search algorithm.

### CROSS-REFERENCE TO RELATED APPLICATIONS

This application claims the benefit of priority from Chinese Patent Application No. 202510782174.6, filed on Jun. 12, 2025. The content of the aforementioned application, including any intervening amendments made thereto, is incorporated herein by reference in its entirety.

### TECHNICAL FIELD

This application relates to inspection of printed circuit boards, and more particularly to a method and system for path planning of a binocular vision-based inspection machine for substrates.

### BACKGROUND

Inspection path planning for printed circuit board (PCB) holes is a complex task involving multi-factor optimization. Reasonably planning the movement path of an inspection device can enhance efficiency and reduce the inspection costs. Conventional automated optical inspection (AOI)-based inspection methods generally use a monocular optical camera to move in a two-dimensional direction according to a path planning algorithm and sequentially capture images of inspection points. Currently, as the precision, integration, and complexity of PCBs continuously increases, a vast number of holes, densely and irregularly distributed, are drilled on a single circuit board. Moreover, higher requirements have been raised for inspection accuracy and speed. Traditional monocular camera-based inspection approaches fail to meet the current production needs due to their limited imaging speed, outdated inspection algorithms, and low inspection efficiency. Furthermore, they do not adequately integrate the characteristics of actual inspection scenarios and the to-be-inspected substrates.

At present, enterprise inspection solutions have gradually evolved toward binocular imaging devices, and inspection efficiency is improved through multi-equipment combined inspection algorithms. As shown in FIG. 1, the improved equipment respectively mounts two inspection cameras and a movable lead screw on two sides of an inspection platform, such that the two cameras perform cooperative imaging inspection in two-dimensional directions. However, major problems include a small size of a to-be-inspected substrate, a large number of to-be-inspected imaging points that are unevenly and randomly distributed, a large interference region between motion ranges of the two cameras, and a high proportion of imaging points located within the interference region. Therefore, the collision interference between the two inspection devices and combined path optimization needs to be fully considered. Conventional path planning algorithms for monocular cameras cannot satisfy inspection efficiency requirements.

### SUMMARY

An object of the disclosure is to provide a method and system for path planning of a binocular vision-based inspection machine for substrates, to overcome the defects in the prior art. The method enables two cameras to cooperatively image a printed circuit board (PCB) with a large number of hole positions, thereby improving inspection efficiency while preventing collisions and interference.

Technical solutions of the present disclosure are described as follows.

In a first aspect, this application provides a path planning method for a binocular vision-based inspection machine for substrates, comprising:
(S1) analyzing and processing dimensional data of a printed circuit board (PCB) substrate and two camera lens modules, wherein the dimensional data comprises parameters of the two camera lens modules and data of the PCB substrate;
(S2) designing a division scheme based on hole position characteristics of the PCB substrate and processed dimensional data, and dividing the PCB substrate into eight working regions based on the two camera lens modules according to the division scheme; constraining working ranges of the two camera lens modules according to sizes and travel ranges of the two camera lens modules; and evaluating collision risks within each of the eight working regions to coordinate movement positions of the two camera lens modules and avoid mutual interference between the two camera lens modules;
(S3) establishing an integer programming model for task pairing scheduling for the two camera lens modules;
according to the eight working regions, assigning a first inspection task group to one of the two camera lens modules, and assigning a second inspection task set to the other of the two camera lens modules, wherein each inspection task in the first inspection task set and the second inspection task set has a determined processing time; and
performing pairing analysis between the first inspection task set and the second inspection task set, wherein two individual tasks without collision risk constitute a process, an individual task that fails to be paired independently forms a process, and a time for each process is determined by a longest processing time of an individual task among tasks within a corresponding process; and
(S4) performing a single-region path planning algorithm, wherein for each of the two camera lens modules, a shortest path connecting all inspection holes within a current region is determined using a variable neighborhood search algorithm.

In some embodiments, in step (S1), a lower-left vertex of the PCB substrate is defined as an origin of a coordinate system; and the PCB substrate has a length of L along an X axis and a width of W along a Y axis;
each of the two camera lens modules has a lens diameter of D, a length of S and a width of T; and
for each of the two camera lens modules, a distance between a lens inspection point and a side away from a cross-shaped sliding stage is P, wherein the lens inspection point is a lens center.

In some embodiments, in step (S2), the two camera lens modules are provided opposite to each other on two sides of an inspection platform, respectively;
each of the two camera lens modules is capable of performing planar movement;
a working range of each of the two camera lens modules is configured to cover the inspection platform;
an X-axis dividing line of the PCB substrate is transversely arranged from a midpoint of the PCB substrate in a Y-axis direction;
a Y-axis dividing line of the PCB substrate is defined such that the PCB substrate is divided into two rectangular regions with equal number of inspection points along the Y-axis direction of the PCB substrate;
a first staggered region and a second staggered region are defined in a front half of the X-axis dividing line of the PCB substrate;
upper ends of the first staggered region and the second staggered region are flush with an upper end of the PCB substrate;
a width of the first staggered region is defined by extending toward a first side of the Y-axis dividing line by a distance of 2P, wherein P is a distance between the lens inspection point and the side of a corresponding one of the two camera lens modules away from the cross-shaped sliding stage;
an edge of the first staggered region away from the Y-axis dividing line is configured as a first dividing line;
upper and lower ends of the first dividing line are connected to upper and lower ends of the PCB substrate, respectively;
a width of the second staggered region is defined by extending toward a second side of the Y-axis dividing line by the distance of 2P;
an edge of the second staggered region away from the Y-axis dividing line is configured as a second dividing line;
upper and lower ends of the second dividing line are connected to the upper and lower ends of the PCB substrate, respectively;
a third staggered region and a fourth staggered region are arranged in a rear half of the PCB substrate, and are respectively mirror-symmetrical to the first staggered region and the second staggered region with respect to the X-axis dividing line;
a third dividing line is transversely arranged at a first coordinate point located at a first side of the X-axis dividing line, and a distance between the first coordinate point and the X-axis dividing line is S/2; a fourth dividing line is transversely arranged at a second coordinate point located at a second side of the X-axis dividing line, and a distance between the second coordinate point and the X-axis dividing line is S/2, wherein S is a length of each of the two camera lens modules;
two ends of the third dividing line are respectively connected to the first dividing line and the second dividing line;
two ends of the fourth dividing line are respectively connected to the first dividing line and the second dividing line;
the first dividing line, the second dividing line, the third dividing line and the fourth dividing line are configured to enclose a rectangular area as a conflict region; and the conflict region is divided by the Y-axis dividing line into two conflict subregions;
an area between the first dividing line and a first edge of the PCB substrate is defined as a first safety region; and an area between the second dividing line and a second edge of the PCB substrate is defined as a second safety region; and
the first staggered region, the second staggered region, the third staggered region, the fourth staggered region, the two conflict subregions, the first safety region and the second safety region together constitute the eight working regions on the PCB substrate.

In some embodiments, in step (S2), the Y-axis dividing line of the PCB substrate is configured to divide the PCB substrate into a first region and a second region; one of the two camera lens modules is configured to operate within the first region; and the other of the two camera lens modules is configured to operate within the second region;
when one of the two camera lens modules is positioned within a corresponding safety region, there is no collision risk for the two camera lens modules;
when the two camera lens modules are respectively located in two staggered regions diagonally opposite, rather than two staggered regions on the same side, no collision occurs; and
when one of the two camera lens modules operates within a conflict subregion, no collision occurs as long as the other of the two camera lens modules is located within its corresponding safety region.

In some embodiments, in step (S3), problem description is as follows:
the two camera lens modules are denoted as a first machine and a second machine, respectively; the first inspection task set does not overlap with the second inspection task set; and the first inspection task set and the second inspection task set are denoted as J^{A}={1, 2 . . . , m} and J^{B}={1, 2 . . . , n}, respectively;
each task is restricted to be executed by one of the two camera lens modules to which it belongs;
a processing time of each task is determined based on a number of inspection points within a corresponding region, such that each task has a predetermined processing time;
a processing time of a task assigned to the first machine is denoted as

$${p}_{i}^{A} ,$$

and a processing time of a task assigned to the second machine is denoted as

$${p}_{i}^{B} ;$$

tasks are executed in a paired mode, wherein one task from the first inspection task set and one task from the second inspection task set are executed simultaneously to form the process, two tasks being referred to as paired tasks;
a duration of the process is determined by one of the paired tasks with a maximum processing time;
tasks that are not paired are executed individually, each forming an independent process, and a duration of the independent process is equal to a processing time of a corresponding task, defined as:

$${T}_{i , j} = max ( {p}_{i}^{A} , {p}_{j}^{B} ) , i ∈ {J}^{A} , j ∈ {J}^{B} ;$$

if a conflict exists between two tasks, the two tasks are not allowed to be paired for inspection; a conflict relationship is given by a conflict matrix C=[C_{i,j}]∈{0,1}^{m×n} wherein

$${C}_{i , j} = \{ \begin{matrix}1 & there is a conflict between task i and task j \\ 0 & task i is allowed to be paired with task j\end{matrix} ;$$

decision variables are expressed as:
   x_{i,j}∈{0,1}: if task i∈J^{A} is paired with task j∈J^{B}, x_{i,j}=1;
      uᵢ∈{0,1}: if task i∈J^{A} is not paired, uᵢ=1; and
         vⱼ∈{0,1}: if task j∈J^{B} is not paired, vⱼ=1;
an objective function is designed to minimize a total execution time of all processes, including paired and unpaired processes, defined as:

$$min {\sum }_{i = 1}^{m} {\sum }_{j = 1}^{n} {x}_{i , j} \cdot max ( {p}_{i}^{A} , {p}_{j}^{B} ) + {\sum }_{i = 1}^{m} {u}_{i} \cdot {p}_{i}^{A} + {\sum }_{j = 1}^{n} {v}_{j} \cdot {p}_{j}^{B} ;$$

constraints are defined as follows:
(1) each task must be executed, and only once:

$${\sum }_{j = 1}^{n} {x}_{i , j} + {u}_{i} = 1 , ∀ i ∈ {J}^{A} ; and$$

$${\sum }_{i = 1}^{n} {x}_{i , j} + {v}_{j} = 1 , ∀ j ∈ {J}^{B} ;$$

paired tasks must satisfy conflict table constraints:

$${x}_{i , j} \leq 1 - {C}_{i , j} , ∀ i ∈ {J}^{A} , j ∈ {J}^{B} ;$$

(2) variables are defined as follows:

$${x}_{i , j} ∈ \{ 0 , 1 \} ; {u}_{i} ∈ \{ 0 , 1 \} ; {v}_{j} ∈ \{ 0 , 1 \} ;$$

wherein x_{i,j} denotes a task pairing result of the two camera lens modules;
uᵢ denotes a task pairing result of one of the two camera lens modules; and
vⱼ denotes a task pairing result of the other of the two camera lens modules.

In some embodiments, in step (S3), in region planning of the two camera lens modules, the two camera lens modules are allowed to perform detection simultaneously;
in order to evaluate efficiency of the path planning method, an equivalent hole count concept is introduced relative to a single-camera detection algorithm, wherein a hole detected simultaneously by the two camera lens modules within the same unit time is counted as one equivalent hole;
when there is a conflict occurring between the detection regions of the two camera lens modules, sequential detection is required, and a hole detected in each of two successive unit times is counted as one equivalent hole, thereby resulting in two equivalent holes;
in the division scheme, a first safety region and a second safety region do not interfere with any other region, whereas a conflict region interferes with non-safety regions, indicating that when one of the two camera lens modules operates in the conflict region, the other of the two camera lens modules is required to operate in a safety region;
considering detection region distribution on the PCB substrate, the conflict region on one side is combined with the safety region on the other side, and such two region combinations are respectively inspected at the beginning and at the end, respectively; two region-planning combination schemes are provided;
in a first combination scheme, a detection order in a first-side region is set as follows:
a first safety region, a first rear staggered region, a first front staggered region and a first conflict region;
in the first combination scheme, a detection order in a second-side region is set as follows:
a second conflict region, a second front staggered region, a second rear staggered region and a second safety region;
in a second combination scheme, a detection order in the first-side region is set as follows:
the first safety region, the first front staggered region, the first rear staggered region and the first conflict region;
in the second combination scheme, a detection order in the second-side region is set as follows:
the second conflict region, the second rear staggered region, the second front staggered region and the second safety region;
one of the two region-planning combination schemes having a minimum equivalent hole count is selected as a region planning result;
after the region-planning combination scheme is determined, regions are detected according to a corresponding detection order;
since the number of detection holes and sizes of the regions are not necessarily identical, it is assumed that when the first machine completes detection of a current region and proceeds to detect a next region, it is required to check a current region of the second machine;
if a conflict exists, the first machine is temporarily blocked, and waits until the second machine moves to another region for re-evaluation; and if no conflict exists, the first machine proceeds to inspect the next region.

In some embodiments, in step (S4), a single-region path planning algorithm is executed, wherein a region detection problem is modeled as a plurality of traveling salesman problems (TSPs), such that the shortest path connecting all detection holes within the current region is calculated;
a starting point is defined at a region vertex to ensure that detection time for each region is maintained constant;
since the PCB substrate is partitioned into a plurality of regions, the number of detection holes within each single region is small, and thus the variable neighborhood search algorithm is applied to solve the plurality of TSPs.

In a second aspect, this application provides a binocular vision-based inspection system for implementing the path planning method described above, and the binocular vision-based inspection system comprising:
a first cross-shaped sliding stage;
a first camera lens module;
an inspection platform;
a second camera lens module;
a second cross-shaped sliding stage; and
a controller;
wherein the first camera lens module is mounted on the first cross-shaped sliding stage;
the second camera lens module is mounted on the second cross-shaped sliding stage;
the first cross-shaped sliding stage and the second cross-shaped sliding stage are arranged in mirror symmetry;
the inspection platform is provided between the first cross-shaped sliding stage and the second cross-shaped sliding stage; and
the first cross-shaped sliding stage, the first camera lens module, the second camera lens module and the second cross-shaped sliding stage are each communicatively connected to the controller.

Compared to the prior art, the present disclosure has the following beneficial effects.

The present disclosure provides a detection path planning algorithm based on region partitioning for a binocular camera inspection system. The PCB substrate is divided into regions according to the dimensions of PCB substrate and the two camera lens modules, and different partitioning schemes are designed based on features of the PCB substrate to ensure applicability of the method. An integer programming model for task pairing scheduling for binocular camera regions is established to solve the tasks. While avoiding collisions and interference, an optimal regional scheduling result is obtained, and for each single region, a variable neighborhood search algorithm based on the traveling salesman problem is employed for rapid path planning. This greatly reduces the detection time and improves equipment efficiency, thereby saving substantial costs for enterprises. Through coordinated operation of two camera lens modules, together with precise region partitioning and intelligent path planning, the method effectively avoids detection blind spots, significantly reducing rates of missed and false detections and ensuring product quality. From a cost standpoint, the high efficiency of the algorithm reduces idle operation time of equipment and lowers energy consumption, while improved detection accuracy prevents rework and scrapping caused by product quality issues, thereby saving substantial maintenance and material costs and providing significant economic benefits and competitive advantages for enterprises.

### BRIEF DESCRIPTION OF THE DRAWINGS

FIG. 1 is a flowchart of a path planning method for a binocular vision-based inspection machine for substrates of the present disclosure;

FIG. 2 is a structural diagram of the binocular vision-based inspection machine of the present disclosure;

FIG. 3 schematically shows key dimensional references of the binocular vision-based inspection machine of the present disclosure;

FIGS. 4A-4B schematically illustrates an eight-working-region partitioning scheme of the present disclosure;

FIG. 5 is a table showing regional conflict relationships of the present disclosure;

FIG. 6 is a flowchart of a variable neighborhood search (VNS) algorithm of the present disclosure; and

FIG. 7 is a data table comparing the performance of embodiments of the present disclosure.

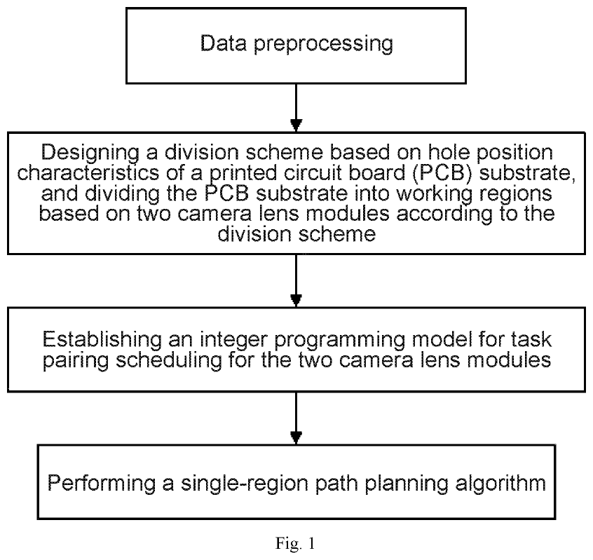

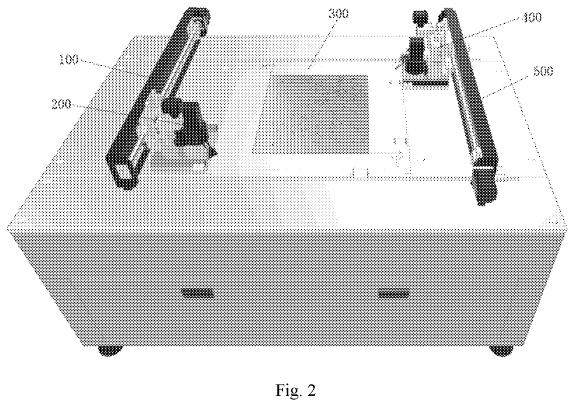

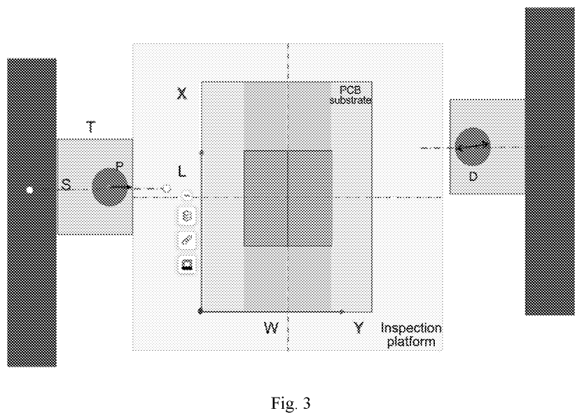

In the figures: 100—first cross-shaped sliding stage; 200—first camera lens module; 300—inspection platform; 400—second camera lens module; and 500—second cross-shaped sliding stage.

### DETAILED DESCRIPTION OF EMBODIMENTS

The embodiments of the present disclosure are described in detail below. The exemplary embodiments are illustrated in the accompanying drawings, in which like or similar reference numerals indicate like or similar elements or elements having like or similar functions throughout the drawings. The embodiments described with reference to the accompanying drawings are merely exemplary and illustrative, and are not intended to limit the disclosure.

An embodiment of the present disclosure provides a path planning method for a binocular vision-based inspection machine for substrates, including the following steps.
(S1) Dimensional data of a printed circuit board (PCB) and two camera lens modules are analyzed and processed, where the dimensional data includes parameters of the two camera lens modules and data of the PCB substrate.
(S2) A division scheme is designed based on hole position characteristics of the PCB substrate and processed dimensional data, and the PCB substrate is divided into eight working regions based on the two camera lens modules according to the division scheme. Working ranges of the two camera lens modules are constrained according to sizes and travel ranges of the two camera lens modules. Collision risks within each of the eight working regions are evaluated to coordinate movement positions of the two camera lens modules and avoid mutual interference between the two camera lens modules.
(S3) An integer programming model for task pairing scheduling for the two camera lens modules is established. According to the eight working regions, a first inspection task set to one of the two camera lens modules is assigned, and a second inspection task set to the other of the two camera lens modules is assigned, where each inspection task in the first inspection task set and the second inspection task set has a determined processing time. Pairing analysis is performed between the first inspection task set and the second inspection task set, where two individual tasks without collision risk constitute a process, an individual task that fails to be paired independently forms a process, and a time for each process is determined by a longest processing time of an individual task among tasks within a corresponding process.
(S4) A single-region path planning algorithm is performed, where for each of the two camera lens modules, a shortest path connecting all inspection holes within a current region is determined using a variable neighborhood search algorithm.

The present disclosure provides a detection path planning algorithm based on region partitioning for a binocular camera inspection system. The PCB substrate is divided into regions according to the dimensions of PCB substrate and the two camera lens modules, and different partitioning schemes are designed based on features of the PCB substrate to ensure applicability of the method. An integer programming model for task pairing scheduling for binocular camera regions is established to solve the tasks. While avoiding collisions and interference, an optimal regional scheduling result is obtained, and for each single region, a variable neighborhood search algorithm based on the traveling salesman problem is employed for rapid path planning. This greatly reduces the detection time and improves equipment efficiency, thereby saving substantial costs for enterprises. Through coordinated operation of two camera lens modules, together with precise region partitioning and intelligent path planning, the method effectively avoids detection blind spots, significantly reducing rates of missed and false detections and ensuring product quality. From a cost standpoint, the high efficiency of the algorithm reduces idle operation time of equipment and lowers energy consumption, while improved detection accuracy prevents rework and scrapping caused by product quality issues, thereby saving substantial maintenance and material costs and providing significant economic benefits and competitive advantages for enterprises.

In some embodiments, in step (S1), a lower-left vertex of the PCB substrate is defined as an origin of a coordinate system. The PCB substrate has a length of L along an X axis and a width of W along a Y axis. Each of the two camera lens modules has a lens diameter of D, a length of S and a width of T. For each of the two camera lens modules, a distance between a lens inspection point and a side away from a cross-shaped sliding stage is P, where the lens inspection point is a lens center.

In the PCB substrate inspection, a primary characteristic is that the PCB substrate is relatively small while the camera lens modules are comparatively large. As a result, collisions and interference are likely to occur during movement. Therefore, it is necessary to strictly partition working regions of the cameras. In the present disclosure, the cameras are symmetrically arranged on two sides of the PCB substrate along a Y-axis direction. The PCB substrate is divided into two rectangular working spaces according to a symmetry axis determined based on a number of inspection points, which is not necessarily a geometric central axis of the PCB substrate, so that the number of inspection points in the two rectangular working spaces is substantially equal. Each camera is restricted to operate only within a predefined working range. Each camera lens module has a length of S and a width of T. A distance P is defined between a lens inspection point and a right-side edge of the camera lens module, where the lens inspection point is the lens center. Together, the dimensions S, T, and P define a rectangular profile of the module with reference to the lens center, such that the lens inspection point lies within the module's outer boundary. When the two camera lens modules operate in relatively close regions, their outer contours, defined with reference to their respective lens centers, may interfere or collide. Therefore, collision-free working regions are defined based on the outer contours of the camera lens modules. This scheme has achieved remarkable results in practical applications. Through strict region partitioning, a large number of potential collision risks during operation are effectively avoided, downtime caused by collision-related maintenance is significantly reduced, and a safe, efficient, and cost-effective inspection solution is provided for enterprises.

In some embodiments, in step (S2), the two camera lens modules are provided opposite to each other on left and right sides of an inspection platform, respectively. Each of the two camera lens modules is capable of performing planar movement. A working range of each of the two camera lens modules is configured to cover the inspection platform. An X-axis dividing line of the PCB substrate is transversely arranged from a midpoint of the PCB substrate in a Y-axis direction. A Y-axis dividing line of the PCB substrate is defined such that the PCB substrate is divided into two rectangular regions with equal number of inspection points along the Y-axis direction of the PCB substrate. A first staggered region and a second staggered region are defined in a front half of the X-axis dividing line of the PCB substrate. Upper ends of the first staggered region and the second staggered region are flush with an upper end of the PCB substrate. A width of the first staggered region is defined by extending toward a left side of the Y-axis dividing line by a distance of 2 P, where P is a distance between the lens inspection point and the side of a corresponding one of the two camera lens modules away from the cross-shaped sliding stage. A left edge of the first staggered region away from the Y-axis dividing line is configured as a first dividing line. Upper and lower ends of the first dividing line are connected to upper and lower ends of the PCB substrate, respectively. A width of the second staggered region is defined by extending toward a right side of the Y-axis dividing line by the distance of 2 P. A right edge of the second staggered region away from the Y-axis dividing line is configured as a second dividing line. Upper and lower ends of the second dividing line are connected to the upper and lower ends of the PCB substrate, respectively. A third staggered region and a fourth staggered region are arranged in a rear half of the PCB substrate, and are respectively mirror-symmetrical to the first staggered region and the second staggered region with respect to the X-axis dividing line. A third dividing line is transversely arranged at a first coordinate point located at a first side of the X-axis dividing line, and a distance between the first coordinate point and the X-axis dividing line is S/2. A fourth dividing line is transversely arranged at a second coordinate point located at a second side of the X-axis dividing line, and a distance between the second coordinate point and the X-axis dividing line is S/2, where S is a length of each of the two camera lens modules. Two ends of the third dividing line are respectively connected to the first dividing line and the second dividing line. Two ends of the fourth dividing line are respectively connected to the first dividing line and the second dividing line. The first dividing line, the second dividing line, the third dividing line and the fourth dividing line are configured to enclose a rectangular area as a conflict region. The conflict region is divided by the Y-axis dividing line into two conflict subregions. An area between the first dividing line and a left edge of the PCB substrate is defined as a first safety region. An area between the second dividing line and a right edge of the PCB substrate is defined as a second safety region. The two first staggered regions, the two second staggered regions, two conflict regions, the first safety region and the second safety region together constitute the eight working regions on the PCB substrate.

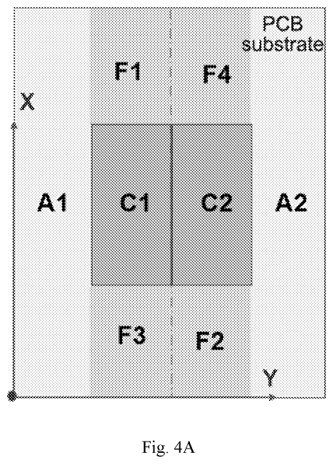

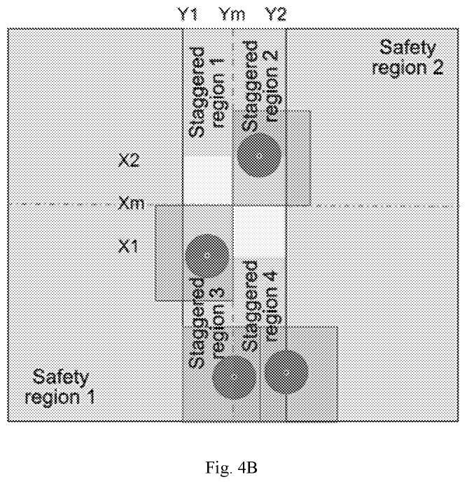

As shown in FIGS. 4A-4B, Xm denotes the X-axis dividing line of the PCB substrate. Ym denotes the Y-axis dividing line of the PCB substrate, which also corresponds to a center line of the number of inspection points. Region divisions along the X-axis include X₁ and X₂, where X₁ represents the fourth dividing line, and X₂ represents the third dividing line. In terms of coordinates, it satisfies

$${X}_{1} = {X}_{m} - \frac{s}{2} and {X}_{2} = {X}_{m} + \frac{s}{2} .$$

Region divisions along the Y-axis include Y₁ and Y₂, where Y₁ represents the first dividing line, and Y₂ represents the second dividing line. In terms of coordinates, it satisfies Y₁=Yₘ−2p and Y₂=Yₘ+2p.

The probability of collision between the camera lens modules varies at different positions within the working space. The closer a camera lens module operates to the center of the PCB substrate, the higher the probability of collision. Therefore, the PCB substrate is partitioned into regions according to the collision risk of different areas, so as to prevent the two camera lens modules from entering high-risk regions simultaneously. From a risk management perspective, this method, by precisely defining high-risk regions, ensures that the occurrence of collisions in high-risk areas is nearly eliminated while maintaining high inspection efficiency.

In some embodiments, in step (S2), the Y-axis dividing line of the PCB substrate is configured to divide the PCB substrate into a first region and a second region. One of the two camera lens modules is configured to operate within the first region, and the other of the two camera lens modules is configured to operate within the second region. When one of the two camera lens modules is positioned within a corresponding safety region, there is no collision risk for the other of the two camera lens modules. When the two camera lens modules are respectively located in two staggered regions diagonally opposite, rather than two staggered regions on the same side, no collision occurs. When one of the two camera lens modules operates within a conflict subregion, no collision occurs as long as the other of the two camera lens modules is located within its corresponding safety region.

A1 and A2 represent safety regions, where no collision occurs when at least one of the camera lens modules is located within a safety region.

F1 and F3 represent the first staggered region and the third staggered region on the left side, while F4 and F2 represent the second staggered region and the fourth staggered region on the right side. F1 and F4 are located at the front and adjacent to each other, and F3 and F2 are located at the rear and adjacent to each other. No collision occurs when the two camera lens modules are not located in staggered regions on the same side.

C1 and C2 represent conflict regions. C1 is adjacent to F1 and F3 at the front and rear, and its left side is adjacent to A1. C2 is adjacent to F4 and F2 at the front and rear, its right side is adjacent to A2, and its left side is adjacent to C1. When one of the camera lens modules operates in a conflict region, no collision occurs if the other camera lens module is located in a safety region. By strictly adhering to the principles of the regional conflict table, significant safety advantages are achieved in actual production scenarios.

In some embodiments, in step (S3), problem description is as follows.

The two camera lens modules are denoted as a first machine and a second machine, respectively, and the first inspection task set does not overlap with the second inspection task set. The first inspection task set and the second inspection task set are denoted as J^{A}={1, 2 . . . , m} and J^{B}={1, 2 . . . , n}, respectively.

Each task is restricted to be executed by one of the two camera lens modules to which it belongs. A processing time of each task is determined based on a number of inspection points within a corresponding region, such that each task has a predetermined processing time. A processing time of a task assigned to the first machine is denoted as piA, and a processing time of a task assigned to the second machine is denoted as piB.

Tasks are executed in a paired mode, where one task from the first inspection task set and one task from the second inspection task set are executed simultaneously to form the process, two tasks being referred to as paired tasks. A duration of the process is determined by one of the paired tasks with a maximum processing time. Tasks that are not paired are executed individually, each forming an independent operation, and a duration of the independent process is equal to a processing process of a corresponding task, defined as:

$${T}_{i , j} = max ( {p}_{i}^{A} , {p}_{j}^{B} ) , i ∈ {J}^{A} , j ∈ {J}^{B} .$$

If a conflict exists between the two tasks, the two tasks are not allowed to be paired for inspection. A conflict relationship is given by a conflict matrix C=[C_{i,j}]∈{0,1}^{m×n}, where

$${C}_{i , j} = \{ \begin{matrix}1 & there is a conflict between task i and task j \\ 0 & task i is allowed to be paired with task j\end{matrix} .$$

Decision variables are expressed as:
x_{i,j}∈{0,1}: if task i∈J^{A} is paired with task j∈J^{B}, x_{i,j}=1;
   uᵢ∈{0,1}: if task i∈J^{A} is not paired, uᵢ=1; and
      vⱼ∈{0,1}: if task j∈J^{B} is not paired, vⱼ=1;

An objective function is designed to minimize a total execution time of all processes, including paired and unpaired processes, defined as:

$$min {\sum }_{i = 1}^{m} {\sum }_{j = 1}^{n} {x}_{i , j} \cdot max ( {p}_{i}^{A} , {p}_{j}^{B} ) + {\sum }_{i = 1}^{m} {u}_{i} \cdot {p}_{i}^{A} + {\sum }_{j = 1}^{n} {v}_{j} \cdot {p}_{j}^{B} .$$

Constraints are defined as follows:
(1) each task must be executed, and only once:

$${\sum }_{j = 1}^{n} {x}_{i , j} + {u}_{i} = 1 , ∀ i ∈ {J}^{A} ; and$$

$${\sum }_{i = 1}^{n} {x}_{i , j} + {v}_{j} = 1 , ∀ j ∈ {J}^{B} .$$

paired tasks must satisfy conflict table constraints:

$${x}_{i , j} \leq 1 - {C}_{i , j} , ∀ i ∈ {J}^{A} , j ∈ {J}^{B} ;$$

and
(2) variables are defined as follows:

$${x}_{i , j} ∈ \{ 0 , 1 \} ; {u}_{i} ∈ \{ 0 , 1 \} ; {v}_{j} ∈ \{ 0 , 1 \} .$$

In the above formula, x_{i,j} denotes a task pairing result of the two camera lens modules, uᵢ denotes a task pairing result of one of the two camera lens modules, and vⱼ denotes a task pairing result of the other of the two camera lens modules.

The problem model exhibits stronger adaptability for more complex multi-region allocation and scheduling problems in the future.

In some embodiments, in step (S3), in region planning of the two camera lens modules, the two camera lens modules are allowed to perform detection simultaneously. In order to evaluate efficiency of the path planning method, an equivalent hole count concept is introduced relative to a single-camera detection algorithm, where a hole detected simultaneously by the two camera lens modules within the same unit time is counted as one equivalent hole. When there is a conflict occurring between the detection regions of the two camera lens modules, sequential detection is required, and a hole detected in each of two successive unit times is counted as one equivalent hole, thereby resulting in two equivalent holes. In the division scheme, a first safety region and a second safety region do not interfere with any other region, whereas a conflict region interferes with non-safety regions, indicating that when one of the two camera lens modules operates in the conflict region, the other of the two camera lens modules is required to operate in a safety region. Considering detection region distribution on the PCB substrate, the conflict region on one side is combined with the safety region on the other side, and such two region combinations are respectively inspected at the beginning and at the end, respectively. Two region-planning combination schemes are provided. In a first combination scheme, a detection order of a left-side region from front to rear is set as follows: a first safety region, a first rear staggered region, a first front staggered region and a first conflict region. In the first combination scheme, a detection order of a right-side region from front to rear is set as follows: a second conflict region, a second front staggered region, a second rear staggered region and a second safety region. In a second combination scheme, a detection order in the left-side region is set as follows: the first safety region, the first front staggered region, the first rear staggered region and the first conflict region. In the second combination scheme, a detection order of in right-side region is set as follows: the second conflict region, the second rear staggered region, the second front staggered region and the second safety region. One of the two region-planning combination schemes having a minimum equivalent hole count is selected as a region planning result. After the region-planning combination scheme is determined, regions are detected according to a corresponding detection order. Since the number of detection holes and sizes of the regions are not necessarily identical, it is assumed that when the first machine completes detection of a current region and proceeds to detect a next region, it is required to check a current region of the second machine. If a conflict exists, the first machine is temporarily blocked and waits until the second machine moves to another region for re-evaluation. If no conflict exists, the first machine proceeds to inspect the next region.

This scheme quantifies performance using the concept of equivalent hole counts. By employing dynamic conflict detection and avoidance strategies, time losses caused by waiting for the cameras are effectively reduced, and equipment coordination efficiency is significantly improved. Moreover, precise region planning reduces frequent large-range movements and adjustments of the cameras, thereby enhancing operational stability.

As shown in FIGS. 4A-4B, two region-planning combination schemes are defined. In a first combination scheme, a detection order in the left-side region is set as follows: A1, F3, F1 and C1; a detection order in the right-side region is C2, F4, F2 and A2.

In a second combination scheme, a detection order in the left-side region is set as follows: A1, F1, F3 and C1; a detection order in the right-side region is C2, F2, F4 and A2.

Among the two combination schemes, the one with the minimum equivalent hole count is selected as the final region-planning scheme.

In some embodiments, in step (S4), a single-region path planning algorithm is executed, where a region detection problem is modeled as a plurality of traveling salesman problems (TSPs), such that the shortest path connecting all detection holes within the current region is calculated. A starting point is defined at a region vertex to ensure that detection time for each region is maintained substantially constant. Since the PCB substrate is partitioned into a plurality of small-scale regions, the number of detection holes within each single region is small, and thus the variable neighborhood search algorithm is applied to solve the plurality of TSPs. The camera lens modules are controlled by a moving platform to move along the obtained shortest path to sequentially image the detection holes, and all detection holes are inspected based on images output by the camera lens modules.

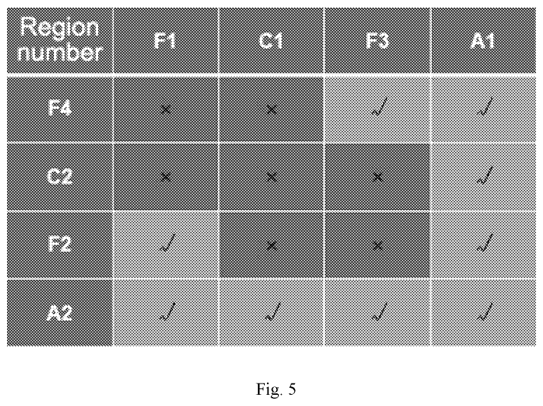

The process of the Variable Neighborhood Search (VNS) algorithm is shown in FIG. 5. First, an initial solution s and a current best solution s_best are set, and an objective function value f_best corresponding to s_best is calculated.

Next, neighborhood structures are defined. The neighborhood operations include two types: (1) N₁(i,j), i.e., which exchanges the elements at positions i and j in the solution sequence; and (2) N₂(i,j), which reverses the subsequence between positions i and j. The iteration counter is then initialized as iter=1.

The algorithm then enters a loop. If iter is less than a preset maximum number of iterations (max_iter), a neighborhood index k is set to 1, and a check is performed to determine whether k is less than the maximum number of neighborhoods (k_max).

If the condition is satisfied, a neighborhood perturbation is performed on the current solution s to obtain a new solution s′, and its objective function value f′ is calculated.

If f′<f_best, the current best solution is updated as s_best=s′, and the best objective value is updated as f_best=f′. Meanwhile, the current solution is set as s=s′, and the neighborhood index k is reset to 1. If f′≥f_best, the neighborhood index k is incremented by 1.

When k≥k_max, the iteration counter iter is incremented by 1, and the process returns to the iteration condition check. This procedure repeats until iter≥max_iter, at which point the current best solution s_best is output.

When applied to path planning, the VNS algorithm can efficiently escape local optima. Conventional local search methods are often trapped in local optima, whereas VNS overcomes this limitation by switching among different neighborhood structures. In the PCB substrate inspection, where inspection points often have a complex or irregular distribution, the algorithm rapidly adjusts the camera movement path, significantly improving solution quality. By alternately applying multiple neighborhood structures, it comprehensively explores the solution space, thereby ensuring inspection accuracy and product quality. Furthermore, the algorithm exhibits strong adaptability in complex and dynamic environments. For instance, when processing different PCB batches or when minor variations in equipment conditions arise, the search strategy can be dynamically adjusted to ensure that the movement path of the camera lens modules remains reasonable, efficient, and safe, thereby maintaining stable inspection performance.

The present disclosure also provides a binocular vision-based inspection system for implementing the path planning method described, including a first cross-shaped sliding stage 100, a first camera lens module 200, an inspection platform 300, a second camera lens module 400, a second cross-shaped sliding stage 500 and a controller. The first camera lens module 200 is mounted on the first cross-shaped sliding stage 100. The second camera lens module 400 is mounted on the second cross-shaped sliding stage 500. The first cross-shaped sliding stage 100 and the second cross-shaped sliding stage 500 are arranged in mirror symmetry. The inspection platform 300 is provided between the first cross-shaped sliding stage 100 and the second cross-shaped sliding stage 500. The first cross-shaped sliding stage 100, the first camera lens module 200, the second camera lens module 400 and the second cross-shaped sliding stage 500 are each communicatively connected to the controller.

### Experimental Computation and Analysis

### 1. Computational Experiments

To verify the feasibility and effectiveness of the proposed region partitioning method and the integer programming model for task pairing scheduling for the two camera lens modules, actual production order data are collected from a PCB manufacturing enterprise for iterative optimization and testing. The iterative optimization algorithm is implemented in Java and compiled using Eclipse 3.7. All experiments are conducted on a Windows 10 system running an Intel i7 CPU (3.60 GHz, 12 cores) with 32 GB RAM.

### 2. Case Study Analysis

To verify the feasibility and applicability of the proposed region partitioning method and path planning algorithm for cases of varying scale and complexity, 36 PCB substrate products from the PCB manufacturing enterprise are used for validation and testing. In order to facilitate industrial implementation and promote practical application of the proposed algorithm, a corresponding software system is also developed. The test cases and experimental design are as follows.

The experiments used PCB substrates in TXT file format, covering 36 types with varying sizes and hole distributions. The input data included the origin position, board length, board width, and defect coordinates. Each board is relatively small (537 mm×429 mm), with a large and uneven number of inspection holes, randomly distributed within a range of 8-220 holes. The interference area affecting movement of the two cameras is substantial (accounting for 25.6% of the board area), and inspection points within the interference area occupy a large proportion of total points (on average 32.06%).

Three experimental schemes are designed for comparison.
Scheme 1: Inspection of the 36 test cases is performed using a monocular camera system, and the equivalent hole count for each case is calculated.
Scheme 2: Without region partitioning, the left and right areas of the PCB substrate are processed using a binocular vision-based system, and a single-region path planning algorithm is applied to each area. The equivalent hole counts for the 36 test cases are calculated.
Scheme 3: The eight-region partitioning algorithm is applied. After region combination, path planning for each region is performed using the binocular vision-based system. The equivalent hole counts for the 36 test cases are calculated.

### Analysis of Experimental Results

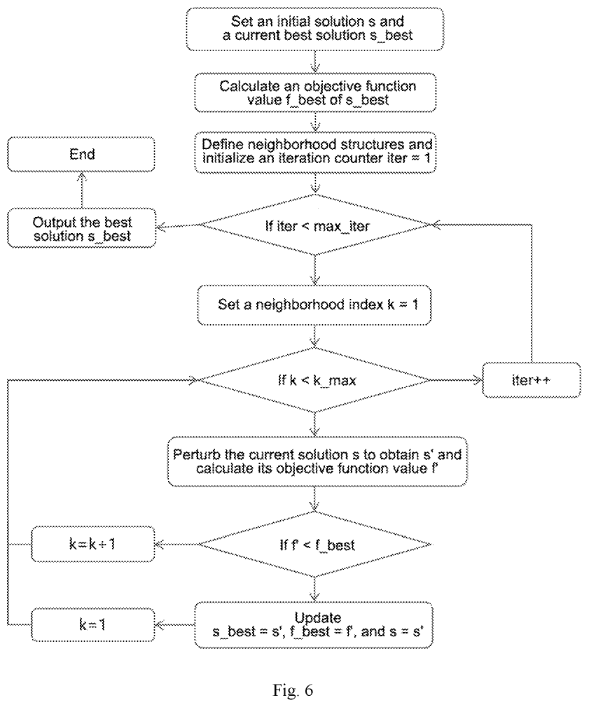

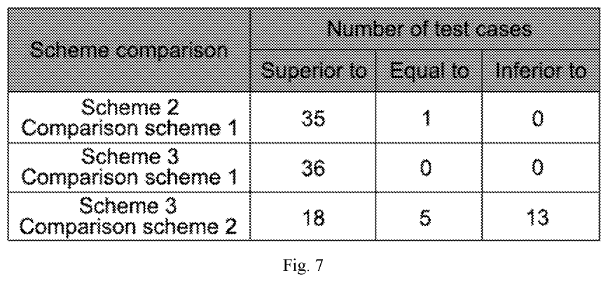

Experiments are conducted on 36 PCB substrate test samples using an eight-region partitioning approach. The comparative results of the three schemes are shown in FIG. 6. Analysis of the results indicates that cooperative imaging with the binocular camera system significantly improves inspection efficiency. For the 36 test cases, both Scheme 2 and Scheme 3 outperform Scheme 1. Among them, Scheme 3 performs better than Scheme 2 in 18 cases, achieves the same performance as Scheme 2 in 5 cases, and underperforms Scheme 2 in 13 cases. The detailed numbers of inspected holes are shown in FIG. 7. On average, the conventional binocular vision-based method (Scheme 2) achieves a 33.33% reduction in total equivalent hole count compared to the monocular method (Scheme 1). With region partitioning, Scheme 3 further reduces the total equivalent hole count by 36.28% relative to Scheme 1. Between the two binocular inspection methods, the total number of inspection operations is reduced. Scheme 3 reduces the number of inspection/photo-capture operations by 44 (approximately 4.42%) compared to Scheme 2. These results indicate that the binocular camera system is significantly more efficient than the monocular system. Moreover, applying the eight-region partitioning further reduces the equivalent hole count for the binocular system compared to the conventional binocular vision-based method.

Described above are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A path planning method for a binocular vision-based inspection machine for substrates, comprising:
(S1) analyzing and processing dimensional data of a printed circuit board (PCB) substrate and two camera lens modules, wherein the dimensional data comprises parameters of the two camera lens modules and data of the PCB substrate;
(S2) designing a division scheme based on hole position characteristics of the PCB substrate and processed dimensional data, and dividing the PCB substrate into eight working regions based on the two camera lens modules according to the division scheme; constraining working ranges of the two camera lens modules according to sizes and travel ranges of the two camera lens modules; and evaluating collision risks within each of the eight working regions to coordinate movement positions of the two camera lens modules and avoid mutual interference between the two camera lens modules;
(S3) establishing an integer programming model for task pairing scheduling for the two camera lens modules;
according to the eight working regions, assigning a first inspection task set to one of the two camera lens modules, and assigning a second inspection task set to the other of the two camera lens modules, wherein each inspection task in the first inspection task set and the second inspection task set has a determined processing time; and
performing pairing analysis between the first inspection task set and the second inspection task set, wherein two individual tasks without collision risk constitute a process, an individual task that fails to be paired independently forms a process, and a time for each process is determined by a longest processing time of an individual task among tasks within a corresponding process; and
(S4) performing a single-region path planning algorithm, wherein for each of the two camera lens modules, a shortest path connecting all inspection holes within a current region is determined using a variable neighborhood search algorithm;
wherein in step (S3), problem description is as follows:
the two camera lens modules are denoted as a first machine and a second machine, respectively; the first inspection task set does not overlap with the second inspection task set; and the first inspection task set and the second inspection task set are denoted as J^{A}={1, 2 . . . , m} and J^{B} {1, 2 . . . , n}, respectively;
each task is restricted to be executed by one of the two camera lens modules to which it belongs;
a processing time of each task is determined based on a number of inspection points within a corresponding region, such that each task has a predetermined processing time;
a processing time of a task assigned to the first machine is denoted as
$${p}_{i}^{A} ,$$
and a processing time of a task assigned to the second machine is denoted as
$${p}_{i}^{B} ;$$
tasks are executed in a paired mode, wherein one task from the first inspection task set and one task from the second inspection task set are executed simultaneously to form the process, two tasks being referred to as paired tasks;
a duration of the process is determined by one of the paired tasks with a maximum processing time;
tasks that are not paired are executed individually, each forming an independent process, and a duration of the independent process is equal to a processing time of a corresponding task, defined as:
$${T}_{i , j} = max ( {p}_{i}^{A} , {p}_{j}^{B} ) , i ∈ {J}^{A} , j ∈ {J}^{B} ;$$
if a conflict exists between two tasks, the two tasks are not allowed to be paired for inspection; a conflict relationship is given by a conflict matrix C=[C_{i,j}]∈{0,1}^{m×n}, wherein
$${C}_{i , j} = \{ \begin{matrix}1 & there is a conflict between task i and task j \\ 0 & task i is allowed to be paired with task j\end{matrix} ;$$
decision variables are expressed as:
x_{i,j}∈{0,1}: if task i∈J^{A} is paired with task j∈J^{B}, x_{i,j}=1;
uᵢ∈{0,1}: if task i∈J^{A} is not paired, uᵢ=1; and
vⱼ∈{0,1}: if task j∈J^{B} is not paired, vⱼ=1;
an objective function is designed to minimize a total execution time of all processes, including paired and unpaired processes, defined as:
$$min {\sum }_{i = 1}^{m} {\sum }_{j = 1}^{n} {x}_{i , j} \cdot max ( {p}_{i}^{A} , {p}_{j}^{B} ) + {\sum }_{i = 1}^{m} {u}_{i} \cdot {p}_{i}^{A} + {\sum }_{j = 1}^{n} {v}_{j} \cdot {p}_{j}^{B} ;$$
constraints are defined as follows:
(1) each task must be executed, and only once:
$${\sum }_{j = 1}^{n} {x}_{i , j} + {u}_{i} = 1 , ∀ i ∈ {J}^{A} ; and$$
$${\sum }_{i = 1}^{n} {x}_{i , j} + {v}_{j} = 1 , ∀ j ∈ {J}^{B} ;$$
paired tasks must satisfy conflict table constraints:
$${x}_{i , j} \leq 1 - {C}_{i , j} , ∀ i ∈ {J}^{A} , j ∈ {J}^{B} ;$$
and
(2) variables are defined as follows:
$${x}_{i , j} ∈ \{ 0 , 1 \} ; {u}_{i} ∈ \{ 0 , 1 \} ; {v}_{j} ∈ \{ 0 , 1 \} ;$$
wherein x_{i,j} denotes a task pairing result of the two camera lens modules;
uᵢ denotes a task pairing result of one of the two camera lens modules; and
v₁ denotes a task pairing result of the other of the two camera lens modules.

2. The path planning method of claim 1, wherein in step (S1),
a lower-left vertex of the PCB substrate is defined as an origin of a coordinate system; and the PCB substrate has a length of L along an X axis and a width of W along a Y axis;
each of the two camera lens modules has a lens diameter of D, a length of S and a width of T; and
for each of the two camera lens modules, a distance between a lens inspection point and a side away from a cross-shaped sliding stage is P, wherein the lens inspection point is a lens center.

3. The path planning method of claim 2, wherein in step (S2),
the two camera lens modules are provided opposite to each other on two sides of an inspection platform, respectively;
each of the two camera lens modules is capable of performing planar movement;
a working range of each of the two camera lens modules is configured to cover the inspection platform;
an X-axis dividing line of the PCB substrate is transversely arranged from a midpoint of the PCB substrate in a Y-axis direction;
a Y-axis dividing line of the PCB substrate is defined such that the PCB substrate is divided into two rectangular regions with equal number of inspection points along the Y-axis direction of the PCB substrate;
a first staggered region and a second staggered region are defined in a front half of the X-axis dividing line of the PCB substrate;
upper ends of the first staggered region and the second staggered region are flush with an upper end of the PCB substrate;
a width of the first staggered region is defined by extending toward a first side of the Y-axis dividing line by a distance of 2P, wherein P is a distance between the lens inspection point and the side of a corresponding one of the two camera lens modules away from the cross-shaped sliding stage;
an edge of the first staggered region away from the Y-axis dividing line is configured as a first dividing line;
upper and lower ends of the first dividing line are connected to upper and lower ends of the PCB substrate, respectively;
a width of the second staggered region is defined by extending toward a second side of the Y-axis dividing line by the distance of 2P;
an edge of the second staggered region away from the Y-axis dividing line is configured as a second dividing line;
upper and lower ends of the second dividing line are connected to the upper and lower ends of the PCB substrate, respectively;
a third staggered region and a fourth staggered region are arranged in a rear half of the PCB substrate, and are respectively mirror-symmetrical to the first staggered region and the second staggered region with respect to the X-axis dividing line;
a third dividing line is transversely arranged at a first coordinate point located at a first side of the X-axis dividing line, and a distance between the first coordinate point and the X-axis dividing line is S/2; a fourth dividing line is transversely arranged at a second coordinate point located at a second side of the X-axis dividing line, and a distance between the second coordinate point and the X-axis dividing line is S/2, wherein S is a length of each of the two camera lens modules;
two ends of the third dividing line are respectively connected to the first dividing line and the second dividing line;
two ends of the fourth dividing line are respectively connected to the first dividing line and the second dividing line;
the first dividing line, the second dividing line, the third dividing line and the fourth dividing line are configured to enclose a rectangular area as a conflict region; and the conflict region is divided by the Y-axis dividing line into two conflict subregions;
an area between the first dividing line and a first edge of the PCB substrate is defined as a first safety region; and an area between the second dividing line and a second edge of the PCB substrate is defined as a second safety region; and
the first staggered region, the second staggered region, the third staggered region, the fourth staggered region, the two conflict subregions, the first safety region and the second safety region together constitute the eight working regions on the PCB substrate.

4. The path planning method of claim 1, wherein in step (S2),
the Y-axis dividing line of the PCB substrate is configured to divide the PCB substrate into a first region and a second region; one of the two camera lens modules is configured to operate within the first region; and the other of the two camera lens modules is configured to operate within the second region;
when one of the two camera lens modules is positioned within a corresponding safety region, there is no collision risk for the two camera lens modules;
when the two camera lens modules are respectively located in two staggered regions diagonally opposite, rather than two staggered regions on the same side, no collision occurs; and
when one of the two camera lens modules operates within a conflict subregion, no collision occurs as long as the other of the two camera lens modules is located within its corresponding safety region.

5. The path planning method of claim 1, wherein in step (S3),
in region planning of the two camera lens modules, the two camera lens modules are allowed to perform detection simultaneously;
in order to evaluate efficiency of the path planning method, an equivalent hole count concept is introduced relative to a single-camera detection algorithm, wherein a hole detected simultaneously by the two camera lens modules within the same unit time is counted as one equivalent hole;
when there is a conflict occurring between the detection regions of the two camera lens modules, sequential detection is required, and a hole detected in each of two successive unit times is counted as one equivalent hole, thereby resulting in two equivalent holes;
in the division scheme, a first safety region and a second safety region do not interfere with any other region, whereas a conflict region interferes with non-safety regions, indicating that when one of the two camera lens modules operates in the conflict region, the other of the two camera lens modules is required to operate in a safety region;
considering detection region distribution on the PCB substrate, the conflict region on one side is combined with the safety region on the other side, and such two region combinations are respectively inspected at the beginning and at the end, respectively;
two region-planning combination schemes are provided;
in a first combination scheme, a detection order in a first-side region is set as follows:
a first safety region, a first rear staggered region, a first front staggered region and a first conflict region;
in the first combination scheme, a detection order in a second-side region is set as follows:
a second conflict region, a second front staggered region, a second rear staggered region and a second safety region;
in a second combination scheme, a detection order in the first-side region is set as follows:
the first safety region, the first front staggered region, the first rear staggered region and the first conflict region;
in the second combination scheme, a detection order in the second-side region is set as follows:
the second conflict region, the second rear staggered region, the second front staggered region and the second safety region;
one of the two region-planning combination schemes having a minimum equivalent hole count is selected as a region planning result;
after the region-planning combination scheme is determined, regions are detected according to a corresponding detection order;
since the number of detection holes and sizes of the regions are not necessarily identical, it is assumed that when the first machine completes detection of a current region and proceeds to detect a next region, it is required to check a current region of the second machine;
if a conflict exists, the first machine is temporarily blocked, and waits until the second machine moves to another region for re-evaluation; and
if no conflict exists, the first machine proceeds to inspect the next region.

6. The path planning method of claim 1, wherein in step (S4), a single-region path planning algorithm is executed, wherein a region detection problem is modeled as a plurality of traveling salesman problems (TSPs), such that the shortest path connecting all detection holes within the current region is calculated;
a starting point is defined at a region vertex to ensure that detection time for each region is maintained constant;
since the PCB substrate is partitioned into a plurality of regions, the number of detection holes within each single region is small, and thus the variable neighborhood search algorithm is applied to solve the plurality of TSPs.

7. A binocular vision-based inspection system for implementing the path planning method of any one of claims 1-6, and the binocular vision-based inspection system comprising:
a first cross-shaped sliding stage;
a first camera lens module;
an inspection platform;
a second camera lens module;
a second cross-shaped sliding stage; and
a controller;
wherein the first camera lens module is mounted on the first cross-shaped sliding stage;
the second camera lens module is mounted on the second cross-shaped sliding stage;
the first cross-shaped sliding stage and the second cross-shaped sliding stage are arranged in mirror symmetry;
the inspection platform is provided between the first cross-shaped sliding stage and the second cross-shaped sliding stage; and
the first cross-shaped sliding stage, the first camera lens module, the second camera lens module and the second cross-shaped sliding stage are each communicatively connected to the controller.
